(19) United States
(12) Patent Application Publication
(10) Pub. No.: US 2008/0242243 A1
(43) Pub. Date: Oct. 2, 2008

(54) Transmission Directional Antenna Control System, Base Station, And Transmission Directional Antenna Control Method Used For System And Base Station

(75) Inventor: Tohru Kikuchi, Tokyo (JP)

Correspondence Address: FOLEY AND LARDNER LLP;SUITE 500, 3000 K STREET NW, WASHINGTON, DC, 20007, US

(73) Assignee: Nec Corporation

(21) Appl. No.: 10/586,589

(22) PCT Filed: Jan. 18, 2005
(86) PCT No.: PCT/JP2005/000506

§ 371 Date: Jul. 20, 2006

(30) Foreign Application Priority Data
Jan. 21, 2004 (JP) 2004-012545

(51) Int. Cl. H04B 7/02

(52) U.S. Cl. 455/101

(57) ABSTRACT

To provide a base station capable of selecting an optimum beam from among transmitted ones of multi-beams. In the arrangement, a beam power determining part (4) determines M received signal powers of multi-beams, and a beam output selecting part (5) selects, based on the information of the received powers from the beam power determining part (4), a beam of the largest power from among M outputs of beam formers (31-3M), and receives the selected beam. A transmission weight generating part (6) selects, based on the received information, a beam corresponding to the signal of a spread code selected by a mobile station and also selects another any beam to notify their respective transmission weighting coefficients. A transmitted beam forming part (7) weights transmitted data corresponding to transmission array antenna elements (91-9N) with the transmission weighting coefficients. Spreaders (81,82) use respective different spread codes to spread input signals, and the transmission array antenna elements (91-9N) send the beam-formed signals.

### TECHNICAL FIELD

The present invention relates to a transmission directional antenna control system, a base station, and a transmission directional antenna control method used for the system and base station, and in particular, it relates to a control method of directivity when transmitting a downward electric wave by a plurality of transmission array antenna elements used for the base station.

### BACKGROUND ART

In a CDMA (Code Division Multiple Access) system, there is a potential of being able to increase a subscriber capacity, and the system is applied as a radio access system of the next generation mobile communication cellular system.

However, there is a problem in that, at the receiving side of a base station, another user's signal simultaneously that contacts the same carrier causes an interference, and at the receiving side of a mobile station, a signal transmitted to another user causes interference.

As a method for eliminating these interferences, there is a technology that uses an array antenna disclosed in Japanese Patent Application Laid-Open No. 2001-7754. The array antenna receives a signal by a plurality of antennas, and performs weighted synthesis of complex numbers, thereby controlling amplitude and phase of the received signal of each antenna to form a directional beam and to suppress the interference from another user.

As one of the control systems of such array antenna, there is a multi-beam system. An example of constitution which uses conventional transmission directional control device (base station) that employs the multi-beam system is shown in FIG. 1. In FIG. 1, in the multi-beam system, first, a signal is received by N pieces (N is an integer of two or more) of antenna elements 111 to 11N adjacently installed by receiving antenna section 110, and each CDMA signal is de-spread by de-spreaders 121 to 12N for each antenna of de-spreading section 120.

For this received signal, receiver beam-forming section 130 multiplies a weight coefficient pre-calculated by a multiplier by using M pieces (M is an integer of two or more) of beam-formers 131 to 13M of the fixed beam, and by synthesizing these multiplied coefficients, the phase and amplitude of the received signal are controlled, and reception is realized by the beams formed in a specific direction. M pieces of these fixed beams are installed such that a predetermined space region (for example, a sector) is covered as uniformly as possible.

At the receiving side, each output power of beam-formers 131 to 13M is measured by beam power detecting section 140, and this received power is notified to a beam output selection synthesizing section 150 together with a beam number. The beam output selection synthesizing section 150 selects and outputs a beam showing a large received power from among these received powers.

In a downward transmission, the transmission weight in the same direction as the beam used at the receiving time is pre-selected in a transmission weight generating section from among the fixed beams forming the beam installed in the same direction as in the upward reception time, and transmission is made by using the beam in the same direction found at the upward reception time by using transmission beam-forming section 170.

### DISCLOSURE OF THE INVENTION

### Problems to be Solved by the Invention

In a multi-beam system, a downward transmission beam is formed in the same direction as the beam direction found by an upward reception, thereby a signal is transmitted. At that time, in a system using FDD (Frequency Division Duplex), a case is considered, where there is a difference in the transmission routes due to a difference of the frequency in the upward and downward transmission routes, and the beam direction found by the upward reception is not always the most appropriate.

Hence, an object of the present invention is to provide a transmission directional antenna control system, a base station, and a transmission directional antenna control method used for the system and base station, which can solve the above described problems and select the most appropriate beam from among the transmission beams of the multi-beam system.

### Means for Solving the Problems

The transmission directional antenna control system according to the present invention is a transmission directional antenna control system in which a base station performs the directional control of transmission array antenna elements according to information from a mobile station, and provides in the base station:
means for forming a transmission multi-beam corresponding to a spread code selected by the mobile station based on a signal spread by different spread codes transmitted from the transmission array antenna elements; and

means for forming an arbitrary multi-beam other than the transmission multi-beam selected by the mobile station.

The base station according to the present invention is a base station performing directional control of the transmission array antenna elements according to information from the mobile station, comprising:

means for forming a transmission multi-beam corresponding to a spread code selected by the mobile station based on a signal spread by different spread codes transmitted from the transmission array antenna elements; and

means for forming an arbitrary multi-beam other than the transmission multi-beam selected by the mobile station.

A transmission directional antenna control method according to the present invention is a transmission directional antenna control method in which the base station performs the directional control of the transmission array antenna elements according to information from the mobile station, comprising the steps of: forming a transmission multi-beam corresponding to a spread code selected by the mobile station based on a signal spread by different spread codes transmitted from the transmission array antenna elements in the base station side; and forming an arbitrary multi-beam other than the transmission multi-beam selected by the mobile station.

That is, the transmission directional antenna control method according to the present invention provides in the base station: a plurality of receiving array antenna elements; a plurality of transmission array antenna elements; means for generating a receiving multi-beam by weight-synthesizing each of received signals from the receiving array antenna elements by a preset weight coefficient, means for detecting the power value of each receiving multi-beam in order to detect the receiving multi-beam of the maximum power, and means for receiving information from a mobile station by the detected receiving multi-beam, transmission weight coefficient generating means for generating a transmission weight coefficient for the transmission data according to information received from the mobile station by allowing the coefficient to correspond to transmission multi-beams corresponding to a plurality of transmission array antenna elements, and means for multiplying a transmission weight coefficient of arbitrary transmission weight coefficient generating means other than the generated multi-beam by the transmission data so as to generate the transmission multi-beam to be spread by each of different spread codes and to be supplied to the corresponding transmission array antenna elements, wherein the directional control of the transmission array antenna elements is performed according to the information from the mobile station.

The transmission directional antenna control system of the present invention provides means for generating the transmission multi-beam according to the spread code selected by the mobile station when each of the signals that are spread by different spread signals transmitted from the transmission array antenna elements by the mobile station are received and the power thereof is compared and the received signal having a large power value is selected and transmitted to the above described transmission weight coefficient generating mean, and provides means for forming the arbitrary multi-beam other than the transmission multi-beam selected by the mobile station.

Further, another transmission directional antenna control system of the present invention provides in the base station: a plurality of receiving array antenna elements; a plurality of transmission array antenna elements; means for forming a receiving beam by determining the arrival direction of each received signal of the receiving array antenna elements and giving a weight thereto, means for receiving information from the mobile station by the formed receiving beam, transmission weight coefficient generating means for generating a transmission weight coefficient for the transmission data according to information received from the mobile station by allowing the coefficient to correspond to transmission beams corresponding to a plurality of transmission array antenna elements, arbitrary transmission weight coefficient generating means other than the generated transmission beam, and means for multiplying these transmission weight coefficients by the transmission data so as to generate the transmission beam to be spread by each of different spread codes and to be supplied to the corresponding transmission array antenna elements, wherein the directional control of the transmission array antenna elements is performed according to the information from the mobile station.

Another transmission directional antenna control system of the present invention provides means for generating the transmission beam corresponding to the spread code selected by the mobile station and means for forming an arbitrary multi-beam other than the transmission beam selected by the mobile station when each of the signals spread by different spread signals transmitted from the transmission array antenna elements by the mobile station is received and the power thereof is compared and the signal having good receiving characteristics is selected and transmitted to the above described transmission weight coefficient generating means.

That is, the transmission directional antenna control system of the present invention transmits a signal for SIR (Signal to Interference power Ratio) measurement by different spread codes and different beams in the downward transmission to the mobile station from the base station, and the SIR is measured by the mobile station, and the signal of the spread having good receiving characteristics is notified to the base station, and the base station transmits the data by the beam corresponding to the spread notified from the mobile station, so that it is possible to realize transmission of a much higher quality.

### ADVANTAGES OF THE INVENTION

The present invention can obtain the advantages of being able to select the most appropriate beam from among the transmission beams of the multi-beam system by the constitution and operation described below.

### BRIEF DESCRIPTION OF THE DRAWINGS

FIG. 1 is a block diagram showing a constitution of a conventional base station;

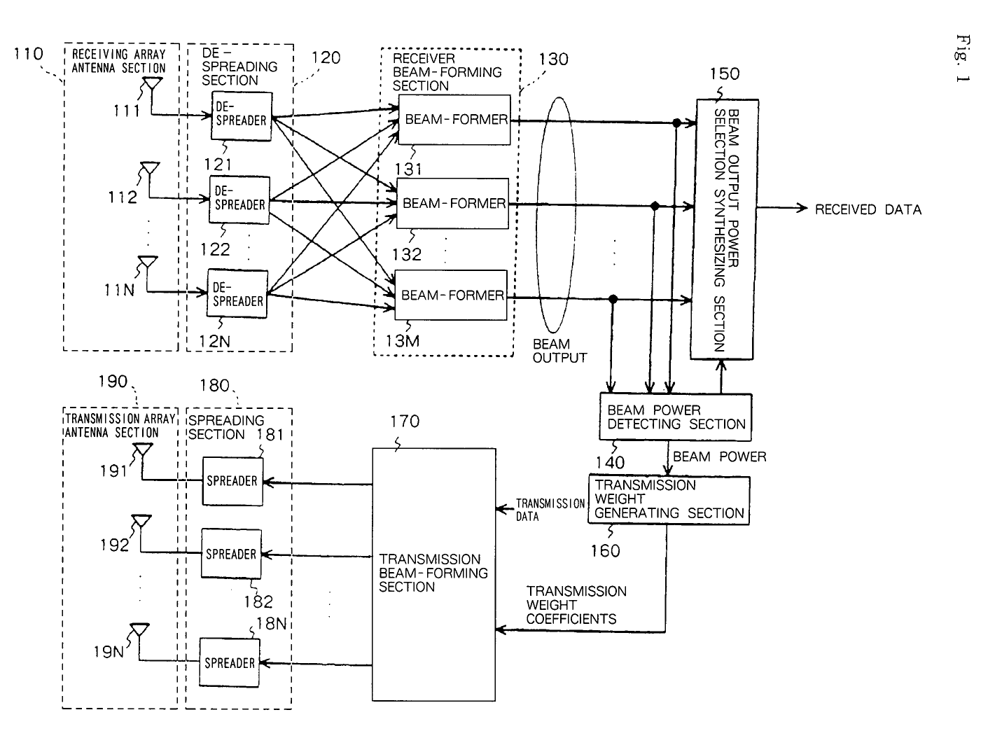

FIG. 2 is a block diagram showing a constitution of a base station according to one embodiment of the present invention;

FIG. 3 is a block diagram showing an example of a constitution of a beam-former of FIG. 1;

FIG. 4 is a block diagram showing a constitutional example of a transmission beam-former of FIG. 1;

FIG. 5 is a flowchart showing the operation of a side of base station according to one embodiment of the present invention;

FIG. 6 is a flowchart showing the operation of a mobile station side according to one embodiment of the present invention; and

FIG. 7 is a block diagram showing a constitution of a base station according to another embodiment of the present invention.

### DESCRIPTION OF REFERENCE NUMERALS

1 RECEIVING ARRAY ANTENNA SECTION
2 INVERSE DIFFUSING SECTION
3, 41 RECEIVER BEAM-FORMING SECTION
4 BEAM POWER DETECTING SECTION
5 BEAM OUTPUT SELECTION SYNTHESIZING SECTION
6 TRANSMISSION WEIGHT GENERATING SECTION
7 TRANSMISSION BEAM-FORMING SECTION
8 DIFFUSING SECTION
9 TRANSMISSION ARRAY ANTENNA SECTION
11 to 1N ARRAY ANTENNA ELEMENT
21 to 2N INVERSE DIFFUSER
31 to 3M BEAM-FORMER
42 BEAM DIRECTION DETECTING SECTION
71, 72 TRANSMISSION BEAM-FORMER
81, 82 DIFFUSER
91 to 9N TRANSMISSION ARRAY ANTENNA ELEMENTS
301, 401 MULTIPLYING SECTION
301-1 to 301-N MULTIPLIER
401-1 to 401-N MULTIPLIER

### BEST MODE FOR CARRYING OUT THE INVENTION

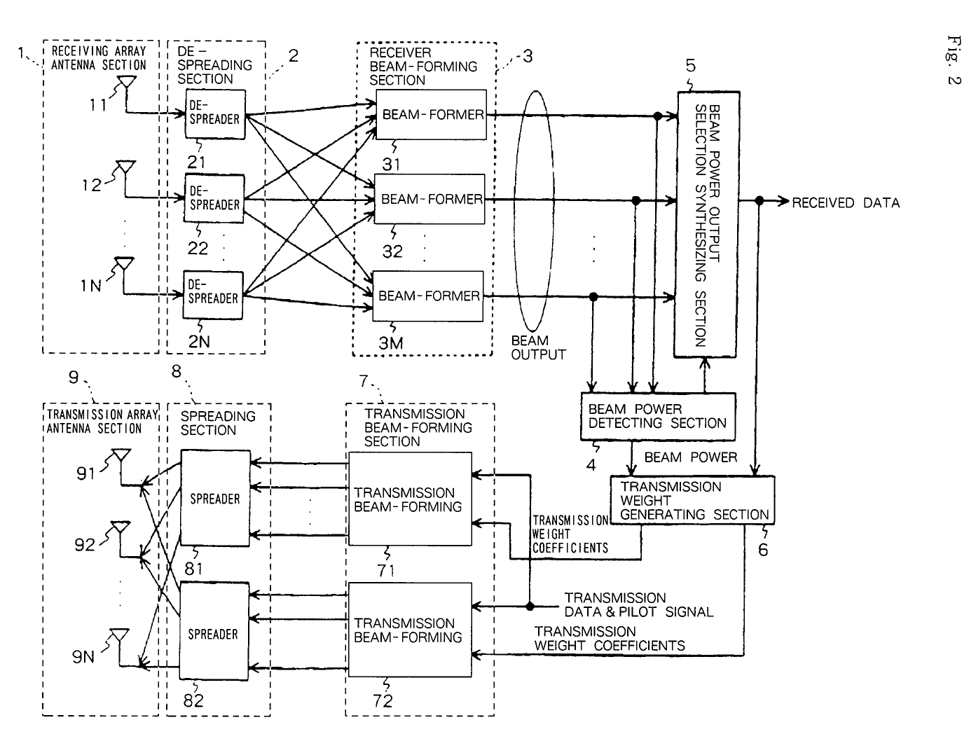

Next, embodiments of the present invention will be described with reference to the drawings. FIG. 2 is a block diagram showing a constitution of a base station according to one embodiment of the present invention. In FIG. 2, a base station according to one embodiment of the present invention constitutes a transmission directional antenna control system together with an unillustrated mobile station, and is constituted by receiving array antenna section 1, de-spreader 2, receiver beam-forming section 3, beam power detecting section 4, beam output selection synthesizing section 5, transmission weight generating section 6, transmission beam-forming section 7, spreader 8, and transmission array antenna section 9.

Receiving array antenna section 1 is comprised of N pieces (N is an integer of two or more) of array antenna elements 11 to 1N, and de-spreading section 2 is comprised of N pieces of de-spreaders 21 to 2N. Receiver beam-forming section 3 is comprised of M pieces (M is an integer of two or more) of beam-formers 31 to 3M.

Transmission beam-forming section 7 is comprised of two pieces of transmission beam-formers 71 and 72, and spread action 8 is comprised of two pieces of spreaders 81 and 82, and transmission array antenna section 9 is comprised of N pieces of transmission array antenna elements 91 to 9N.

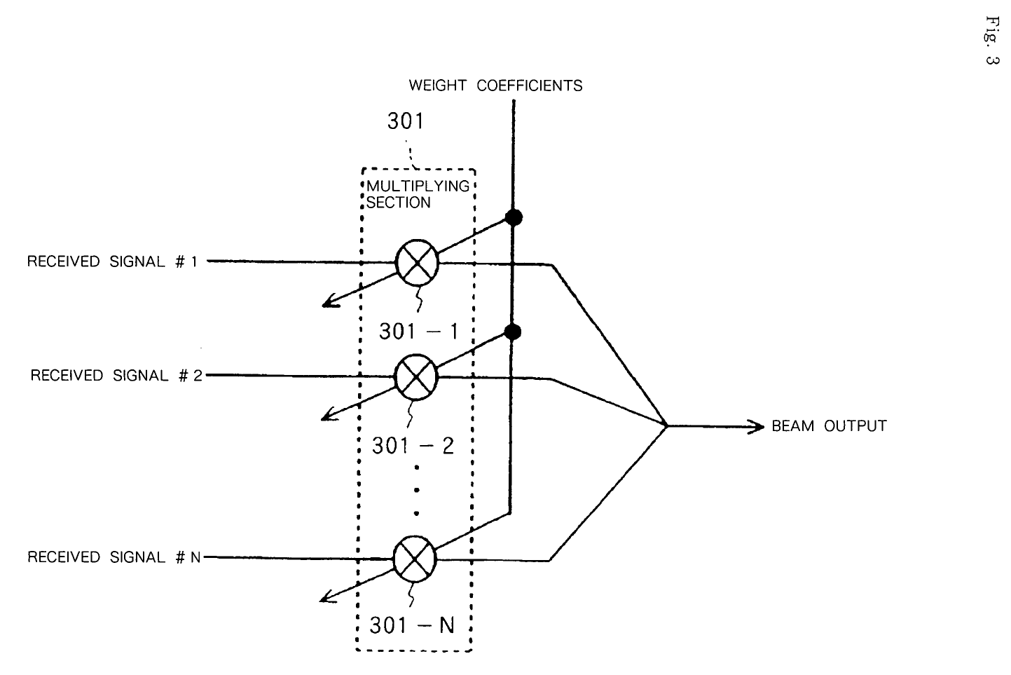

FIG. 3 is a block diagram showing an example of constitution beam-formers 31 to 3M of FIG. 2. Beam-formers 31 to 3M shown in FIG. 2 are constituted by multiplying section 301 comprising multipliers 301-1 to 301-N shown in FIG. 3.

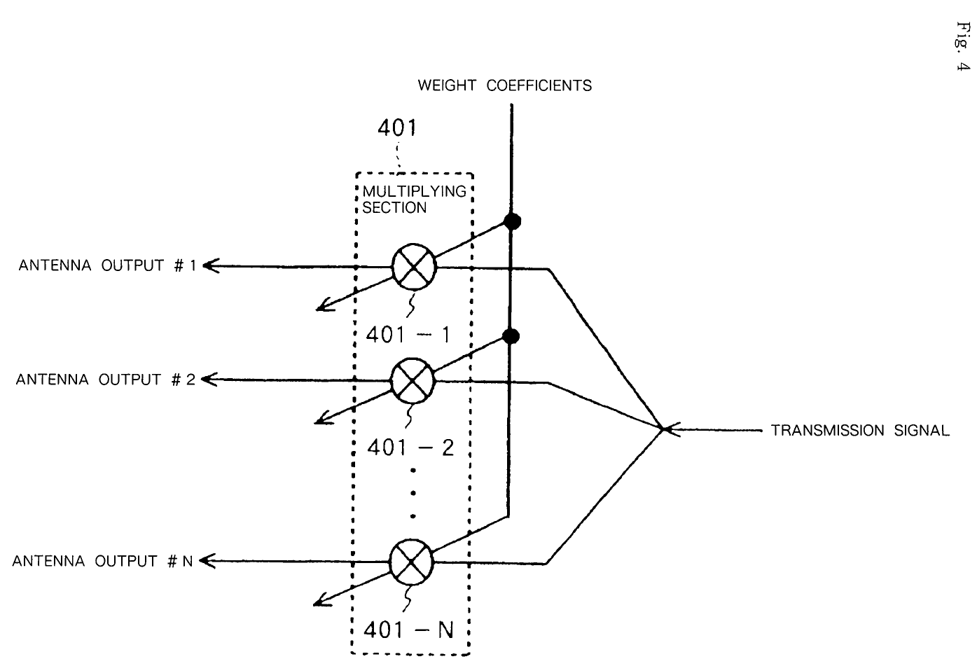

FIG. 4 is a block diagram showing an example of constitution transmission beam-formers 71 and 72 of FIG. 2. Transmission beam-formers 71 and 72 shown in FIG. 2 are constituted by multiplying section 401 comprising multipliers 401-1 to 401-N shown in FIG. 4.

A transmission directional antenna control device according to one embodiment of the present invention will be described with reference to FIGS. 2 to 4. The signals received by N pieces of array antenna elements 11 to 1N are de-spread by de-spreaders 21 to 2N which correspond to each of the antenna elements.

Each of the de-spread signals is inputted to each of M pieces of beam-formers 31 to 3M. The beam-formers 31 to 3M, as shown in FIG. 3, perform weight synthesis by weight coefficients pre-calculated by multipliers 301-1 to 301-N for the received signals, so that M pieces of multi-beam outputs are generated.

M pieces of beam outputs beamformed by the beam-formers 31 to 3M are inputted to beam power detecting section 4 and beam output selection section 5. Beam power detecting section 4 finds each of received signal power values of M pieces of the multi-beams, and the result thereof is outputted to beam output selection section 5 and transmission weight generating section 6.

Beam output selection section 5 receives a signal by selecting the beam having the maximum power from among the outputs of M pieces of the beam-formers 31 to 3M based on information on the received power value from power selecting section 4, and the received information is outputted to an unillustrated internal circuit and to transmission weight generating section 6.

Transmission weight generating section 6 provides a transmission weight coefficient corresponding in advance to a receiving weight, and the beam that corresponds to the signal of the spread selected by the mobile station (not shown) from the received information and from arbitrary beam other than that beam, are selected, and each of transmission weight coefficients thereof is notified to the transmission beam-forming section 7.

Transmission beam-forming section 7, as shown in FIG. 4, gives a transmission weight coefficient to the transmission data corresponding to each of transmission array antenna elements 91 to 9N by multipliers 401-1 to 401-N, and outputs the data to spreading section 8. Spreaders 81 and 82 spread input signals by different spread codes and output them to transmission array antenna elements 91 to 9N, and these signals are transmitted as beamformed signals.

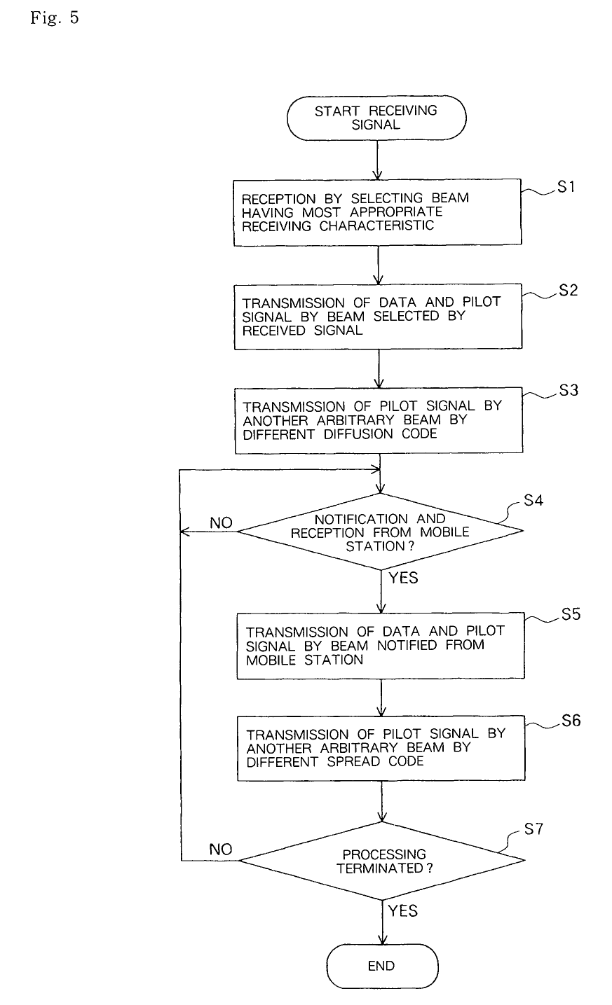

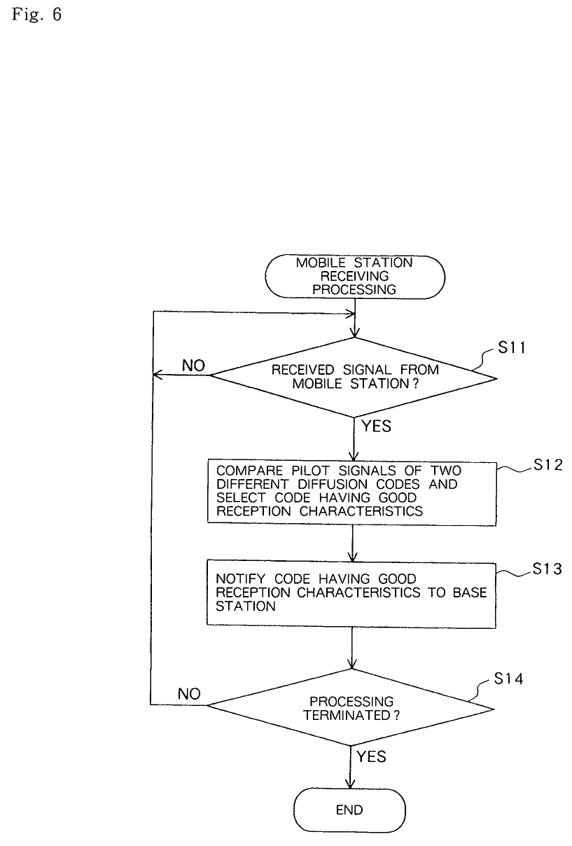

FIG. 5 is a flowchart showing the operation of the side of a base station side according to one embodiment of the present invention, and FIG. 6 is a flowchart showing the operation of a mobile station side according to one embodiment of the present invention. With reference to these FIGS. 2 to 6, the operation of the transmission directional antenna control system according to one embodiment of the present invention will be described.

Receiving array antenna section 1 of the base station carries a plurality of array antenna elements 11 to 1N, and receives a CDMA signal. Inverse-spreading section 2 carries N pieces of de-spreaders 21 to 2N, and de-spreads each of the outputs of array antenna elements 11 to 1N.

Receiving beam-forming section 3 carries M pieces of beam-formers 31 to 3M, and upon receipt of the output of de-spreading section 2, implements multi-beam forming, and forms M pieces of beam outputs. Beam power detecting portion 4, upon receipt of the output of the beam-formers 31 to 3M, performs power measurement for each beam.

Beam output selection section 5, based on power information on each beam from beam power detecting section 4, receives a signal from the beam having a large output level from among the beams. Transmission weight generating section 6, based on power information on each beam from beam power detection section 4 and on information about the signal received from beam output selection section 5, generates two different transmission weight coefficients and notifies them to beam-forming section 7.

Beamforming section 7 performs the beam-forming of each transmission signal from the two different transmission weight coefficients from transmission weight generating section 6 and notifies the beam-formed signals to spreading section 8. Diffusing section 8 subjects the two different beam-formed signals to spread by each of two different spread for each of the transmission array antenna elements 91 to 9N, and outputs the spread signals to transmission array antenna section 9, and these signals are transmitted from transmission array antenna section 9.

Next, the operation of transmission weight generating section 6, beam-forming section 7, and spreading section 8 will be described. Transmission weight generating section 6, upon starting reception with the mobile station, first, receives the output power value from each received multi-beam from beam power detecting section 4, then selects the beam having maximum power, and selects a transmission weight pre-calculated by corresponding to the selected receiving multi-beam (step S1 in FIG. 5). Further, transmission weight generating section 6 selects an arbitrary multi-beam other the selected multi-beam, and notifies each transmission weight thereof to transmission beam-formers 71 and 72.

Transmission beam-formers 71 and 72 perform beam-forming for the transmission beam that corresponds to the beam having the maximum power of the transmission multi-beam with respect to pilot signal for reception SIR measurement and the transmission data, and performs the beam-forming on the pilot signal only for the arbitrary multi-beam other than the transmission beam.

The signals beamformed by these two transmission beam-formers 71 and 72 are outputted to each of the two different spreaders 81 and 82, and are spread by two different spread codes by spreaders 81 and 82, and are transmitted to the mobile station from transmission array antenna section 9 (steps S2 and S3 in FIG. 5).

The mobile station, upon receipt of the pilot signals having the two different spread codes from transmission array antenna section 9 (step S11 in FIG. 6), finds the SIR of those signals, and selects the code having good receiving characteristics, and notifies the selected code to the base station (steps S12 and S13 in FIG. 6).

The base station, upon receipt of the signal from the mobile station again (step S4 in FIG. 5), performs de-spreader and beam-forming on the signal, and receives the signal by the receiving multi-beams in which the power becomes the maximum.

Here, transmission weight generating section 6, based on information from the mobile station, selects the multi-beam corresponding to the spread code selected by the mobile station. Further, transmission weight generating section 6 selects the arbitrary multi-beam other than the selected beam, and notifies each of the transmission weights thereof to transmission beam-formers 71 and 72.

Transmission beam-formers 71 and 72 perform the beam-forming on the pilot signal and on the transmission data for the beam corresponding to the code notified from the mobile station and selected by the mobile station, and performs the beam-forming on the pilot signal only for the arbitrary beam other than those beams. These signals are subjected to spread two different spread codes by spreaders 81 and 82, and are transmitted to the mobile station from transmission array antenna section 9 (steps S5 and S6 in FIG. 5).

In the present embodiment, during a period when the base station and the mobile station communicate with each other, the above described processing operation is repeatedly performed in the base station (steps 4 to 7 in FIG. 5). In the mobile station also, the above described processing operation is repeatedly performed (steps S11 to S14 in FIG. 6), so that a more appropriate downward transmission beam can be selected.

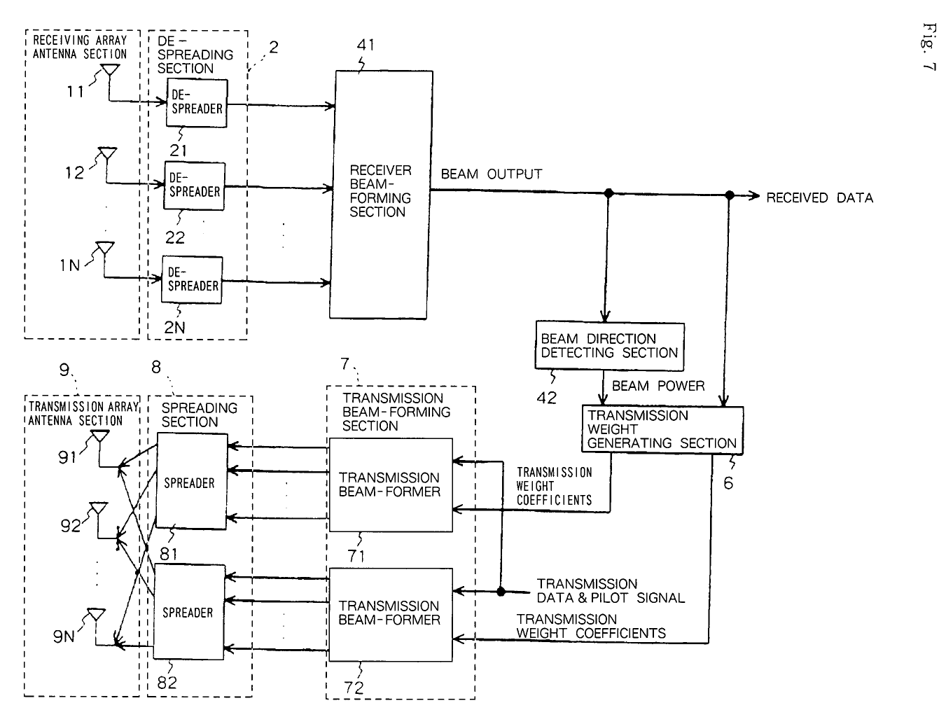

FIG. 7 is a block diagram showing a constitution of a base station according to another embodiment of the present invention. In FIG. 7, a base station according to another embodiment of the present invention, similar to the above described one embodiment of the present invention, constitutes a transmission directional antenna control system together with an unillustrated mobile station, and comprises receiving array antenna section 1, de-spreading section 2, receiver beam-forming section 41, beam direction detecting section 42, transmission weight generating section 6, transmission beam-forming section 7, spreading section 8, and transmission array antenna section 9.

In another embodiment of the present invention, the beam-forming method for one embodiment of the present invention is further elaborated. Receiver beam-forming section 41 assumes a case where an algorism [for example, MMSE (Minimum Mean Square Error)] is used to direct the beam by adaptively determining an arrival direction of a received signal, and together with this, takes beam power detecting section 4 as beam direction detecting section 42.

At this time, receiver beam-forming section 41 forms the beam corresponding to an arrival direction of the received signal, and thereby receives the signal. The received signal is inputted to beam direction detecting section 42 and transmission weight generating section 6. Beam direction detecting section 42 detects an arrival direction of the assumed beam, and notifies the direction to transmission weight generating section 6.

Transmission weight generating section 6, when starting reception with the mobile station, first, receives an arrival direction from beam direction detecting section 42, and than calculates a transmission weight coefficient corresponding to the arrival direction. Further, transmission weight generating section 6 calculates a beam showing an arbitrary direction (for example, +10 degrees) in addition to the calculated beam, and notifies each of the transmission weight coefficients thereof to transmission beam-formers 71 and 72.

Transmission beam-formers 71 and 72 perform the beam-forming an the pilot signal and on the data with respect to the beam corresponding to the beam having the arrival direction that is assumed, and performs the beam-forming on the pilot signal only with respect to the arbitrary beams other than those beam. These two beam-formed signals are inputted into each of two different spreaders 81 and 82, and are spread by two different spread codes, and are transmitted to the mobile station from transmission array antenna section 9.

The mobile station receives the pilot signals having two different spread codes, and selects the code having good receiving characteristics, and notifies the selected code to the base station. The base station, upon receipt of the signal from the mobile station again, similar to the above description, performs de-spreading and beam-forming, and receives a signal by the beam directed to the arrival direction of the signal.

Here, transmission weight generating section 6 selects the beam corresponding to the spread code selected by the mobile station from information from the mobile station. Further, the transmission weight generating section 6 calculates the arbitrary beam other than the selected beam, and notifies each of the transmission weight coefficients thereof to transmission beam-formers 71 and 72.

Transmission beam-formers 71 and 72 perform the beam-forming on the pilot signal and on the data with respect to the beam corresponding to the code (selected code) notified from the mobile station, and perform the beam-forming on the pilot signal only with respect to the arbitrary beam other that beam.

These signals are again subjected to spread by two different codes again, and are transmitted to the mobile station. In the present embodiment, this processing operation is repeatedly performed, so that a more appropriate downward transmission beam can be selected.

In this manner, in the present embodiment, since assumption about the arrival direction assumption is performed for reception of the upward signal, transmission beam-forming can be performed based on a more highly accurate beam.

In this manner, in the present invention, the most appropriate beam can be selected from among transmission beams of the multi-beam. Incidentally, the present invention is not limited to each of the above described embodiments, and it is to be noted that each embodiment can be suitably modified within the scope of the invention.

1. A transmission directional antenna control system, in which a base station performs the directional control of transmission array antenna elements according to information from a mobile station,
said transmission directional antenna control system, providing in the base station:
means for forming a transmission multi-beam corresponding to a spread code selected by said mobile station based on a signal spread by different spread codes transmitted from said transmission array antenna elements; and
means for forming an arbitrary multi-beam other than the transmission multi-beam selected by said mobile station.

2. The transmission directional antenna control system according to claim 1, wherein each of signals for SIR measurement is transmitted by different spread codes and different beams in a downward transmission to said mobile station from said base station, and a signal of the spread code having good receiving characteristics obtained by measuring said SIR by said mobile station is notified to said base station, and said base station transmits data by a beam corresponding to the spread code notified from said mobile station.

3. The transmission directional antenna control system according to claim 1 or claim 2, providing in said base station:
a plurality of receiving array antenna elements;
a plurality of transmission array antenna elements;
means for weight-synthesizing each of received signals from said receiving array antenna elements by a preset weight coefficient and for generating a receiving multi-beam;
means for detecting each of the power values of said receiving multi-beam and receiving information from said mobile station by the receiving multi-beam having the maximum power;
means for generating a transmission weight coefficient for transmission data according to information received from said mobile station for each transmission multi-beam corresponding to each of the plurality of transmission array antenna elements;
means for generating the transmission weight coefficient of an arbitrary multi-beam other than the multi-beam in which said transmission weight is generated; and
means for generating said transmission multi-beam by multiplying these transmission weight coefficients by said transmission data and spreading these transmission multi-beams by each of the different spread codes to be supplied to the corresponding transmission array antenna elements,
wherein said base station performs the directional control of said transmission array antenna elements according to information from said mobile station.

4. The transmission antenna directional control system according to claim 1 or claim 2, providing in said base station:
a plurality of receiving array antenna elements;
a plurality of transmission array antenna elements;
means for generating a receiver beam by adaptively determining an arrival direction of each of received signals from said receiving array antenna elements and giving a weight thereto;
means for receiving information from said mobile station by the formed receiving beam;
means for generating a transmission weight coefficient for transmission data that corresponds to information received from said mobile station for each transmission beam corresponding to each of the plurality of transmission array antenna elements;
means for generating the transmission weight coefficient of an arbitrary multi-beam other than the transmission beam in which said transmission weight coefficient is generated; and
means for generating said transmission beam by multiplying these transmission weight coefficients by said transmission data and spreading these transmission multi-beams by each of the different spread codes to be supplied to the corresponding transmission array antenna elements,
wherein said base station performs directional control of said transmission array antenna elements according to information from said mobile station.

5. A base station performing the directional control of transmission array antenna elements according to information from a mobile station, comprising:
means for forming a transmission multi-beam corresponding to a spread code selected by said mobile station based on a signal spread by different spread codes transmitted from said transmission array antenna elements; and
means for forming an arbitrary multi-beam other than the transmission multi-beam selected by said mobile station.

6. The base station according to claim 5, wherein each of the signals for SIR measurement is transmitted by different spread codes and different beams in a downward transmission to said mobile station, and when a signal of the spread code and which has good receiving characteristics is notified to said base station, the data is transmitted by a beam corresponding to the spread code.

7. The base station according to claim 5 or claim 6, comprising:
a plurality of receiving array antenna elements;
a plurality of transmission array antenna elements;
means for weight-synthesizing each of the received signals from said receiving array antenna elements by a preset weight coefficient and for generating a receiving multi-beam;
means for detecting each of the power values of said receiving multi-beam and receiving information from said mobile station by the receiving multi-beam having maximum power;
means for generating the transmission weight coefficient for the transmission data according to information received from said mobile station for each transmission multi-beam corresponding to each of the plurality of transmission array antenna elements;
means for generating the transmission weight coefficient of an arbitrary multi-beam other than the multi-beam in which said transmission weight coefficient is generated; and
means for generating said transmission multi-beam by multiplying these transmission weight coefficients by said transmission data and spreading these transmission multi-beams by each of the different spread codes to be supplied to the corresponding transmission array antenna elements,
wherein said base station performs the directional control of said transmission array antenna elements according to information from said mobile station.

8. The base station according to claim 5 or claim 6, comprising:
a plurality of receiving array antenna elements;
a plurality of transmission array antenna elements;
means for forming a receiving beam by adaptively determining an arrival direction of each of the received signals from said receiving array antenna elements and giving a weight thereto;
means for receiving information from said mobile station by the formed receiving beam;
means for generating the transmission weight coefficient for transmission data corresponding to information received from said mobile station for each transmission beam corresponding to each of the plurality of transmission array antenna elements; and
means for generating the transmission weight coefficient of an arbitrary multi-beam other than the transmission beam in which said transmission weight coefficient is generated; and
means for generating said transmission beam by multiplying these transmission weight coefficients by said transmission data and spreading these transmission multi-beams by each of the different spread codes to be supplied to the corresponding transmission array antenna elements,
wherein said base station performs the directional control of said transmission array antenna elements according to information from said mobile station.

9. A transmission directional antenna control method in which a base station performs the directional control of transmission array antenna elements according to information from a mobile station, said transmission direction antenna control method, comprising the steps of:
forming a transmission multi-beam corresponding to the spread code selected by said mobile station based on a signal spread by different spread codes transmitted from said transmission array antenna elements performed by said base station side; and
forming an arbitrary multi-beam other than the transmission multi-beam selected by said mobile station.

10. The transmission directional antenna control method according to claim 9, wherein each of the signals for SIR measurement is transmitted by different spread codes and different beams in a downward transmission to said mobile station from said base station, and a signal that is spread by the spread code and which has good receiving characteristics obtained by measuring said SIR by said mobile station is notified to said base station, wherein said base station transmits data by a beam corresponding to the spread code notified from said mobile station.

11. The transmission antenna directional control method according to claim 9 or claim 10, providing in said base station:
a plurality of receiving array antenna elements;
a plurality of transmission array antenna elements;
means for weight-synthesizing each of the received signals from said receiving array antenna elements by a preset weight coefficient and for generating a receiving multi-beam;
means for detecting each of the power of values receiving multi-beams and for receiving information from said mobile station by the receiving multi-beam having the maximum power;
means for generating the transmission weight coefficient for transmission data according to information received from said mobile station for each transmission multi-beam corresponding to each of the plurality of transmission array antenna elements;
means for generating the transmission weight coefficient of an arbitrary multi-beam other than the multi-beam in which said transmission weight coefficient is generated, and
means for multiplying these transmission weight coefficients by said transmission data to generate said transmission multi-beam and spreading these transmission multi-beams by each of the different spread codes to be supplied to the corresponding transmission array antenna elements,
wherein said base station performs the directional control of said transmission array antenna elements according to information from said mobile station.

12. The transmission antenna directional control method according to claim 9 or claim 10, comprising:
a plurality of receiving array antenna elements;
a plurality of transmission array antenna elements;
means for forming a receiver beam by adaptively determining an arrival direction of each of received signals from said receiving array antenna elements and giving a weight thereto;
means for receiving information from said mobile station by the formed receiver beams;
means for generating the transmission weight coefficient for transmission data corresponding to information received from said mobile station for each transmission beam corresponding to each of the plurality of transmission array antenna elements; and
means for generating the transmission weight coefficient of an arbitrary multi-beam other than the transmission beam in which said transmission weight beam is generated, and
means for generating said transmission beam by multiplying these transmission weight coefficients by said transmission data and spreading these transmission multi-beams by each of the different spread codes to be supplied to the corresponding transmission array antenna elements,
wherein said base station performs the directional control of said transmission array antenna elements according to information from said mobile station.
